(19) United States
(12) Patent Application Publication
(10) Pub. No.: US 2013/0209973 A1
(43) Pub. Date: Aug. 15, 2013

(54) Methods and Systems for Tracking Words to be Mastered

(71) Applicant: Carl I. Teitelbaum, Brooklyn, NY (US)

(72) Inventor: Carl I. Teitelbaum, Brooklyn, NY (US)

(21) Appl. No.: 13/371,855

(22) Filed: Feb. 13, 2012

(51) Int. Cl. G09B 19/00

(52) U.S. Cl. 434/156

(57) ABSTRACT

A method for tracking words to be mastered includes transmitting, by a first computing device, to a second computing device, a word for reading by a user of the second computing device. The method includes receiving, by the first computing device, from the second computing device, an indication that the user requested assistance with sight-reading the word. The method includes adding, by the first computing device, the word to an enumeration of words the user has not mastered. The method includes providing, by the first computing device, to an instructor of the user, the enumeration of words the user has not mastered.

### BACKGROUND

The disclosure relates to tracking words. More particularly, the methods and systems described herein relate to tracking words to be mastered.

Conventional systems for assisting individuals who are learning to read with tracking words to be mastered typically depend upon individuals to remember which words they need to learn or struggle to master; such self-reporting may lead to over- or under-inclusive identification of challenging words. Other typical systems depend upon instructors identifying words they believe individuals need to learn, which again may lead to over- or under-inclusive identification of challenging words. Further, in some systems where the instructors depend upon individuals to communicate the words they find challenging, there may be a disincentive for the individuals to call attention to themselves—for example, out of embarrassment in a classroom setting.

### SUMMARY

In one aspect, a method for tracking words to be mastered includes transmitting, by a first computing device, to a second computing device, a word for reading by a user of the second computing device. The method includes receiving, by the first computing device, from the second computing device, an indication that the user requested assistance with sight-reading the word. The method includes adding, by the first computing device, the word to an enumeration of words the user has not mastered. The method includes providing, by the first computing device, to an instructor of the user, the enumeration of words the user has not mastered.

In another aspect, a system for tracking words to be mastered includes a media delivery component executing on a first computing device and a word tracking component executing on the first computing device. The media delivery component transmits, to a client application executing on a second computing device, a word for reading by a user of the second computing device. The word tracking component receives, from the second computing device, an indication that the user requested assistance with sight-reading the word. The word tracking component adds the word to an enumeration of words the user has not mastered. The word tracking component provides, to an instructor of the user, the enumeration of words the user has not mastered.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A-1C are block diagrams depicting embodiments of computers useful in connection with the methods and systems described herein;

FIG. 2A is a block diagram depicting an embodiment of a system for tracking words to be mastered;

FIG. 2B is a block diagram depicting an embodiment of a user interface displaying words to be sight-read;

FIG. 3 is a flow diagram depicting an embodiment of a method for tracking words to be mastered;

FIG. 4A is a screen shot depicting one embodiment of a user interface for viewing the enumeration of words the user has not mastered;

FIG. 4B is a screen shot depicting one embodiment of a user interface for modifying an enumeration of words the user has not mastered; and

FIG. 4C is a screen shot depicting one embodiment of a user interface reflecting a user-initiated modification to the enumeration of words the user has not mastered.

### DETAILED DESCRIPTION

In some embodiments, the methods and systems described herein provide functionality for tracking words to be mastered. Before describing these methods and systems in detail, however, a description is provided of a network in which such methods and systems may be implemented.

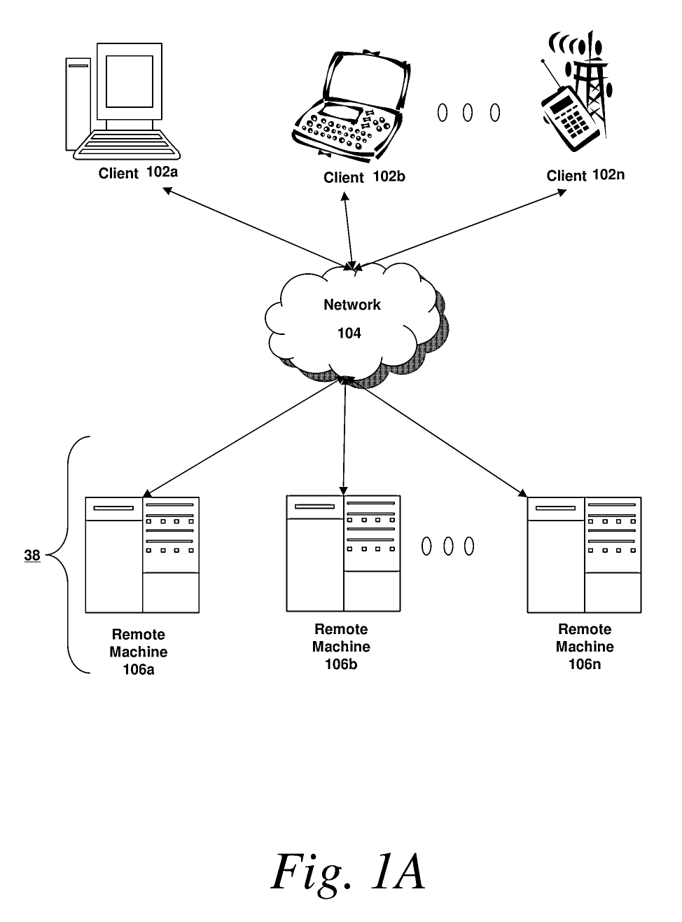

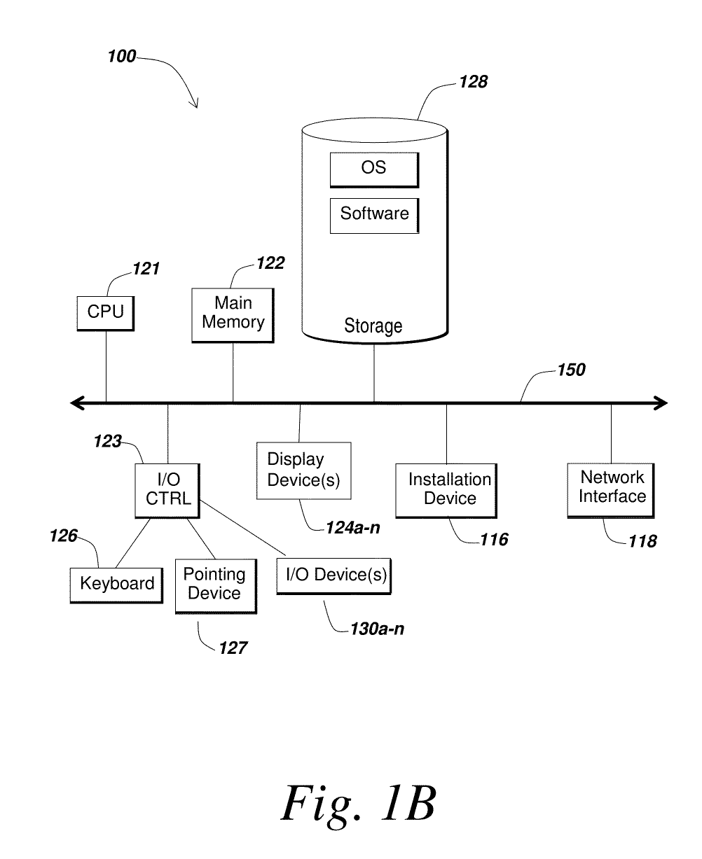

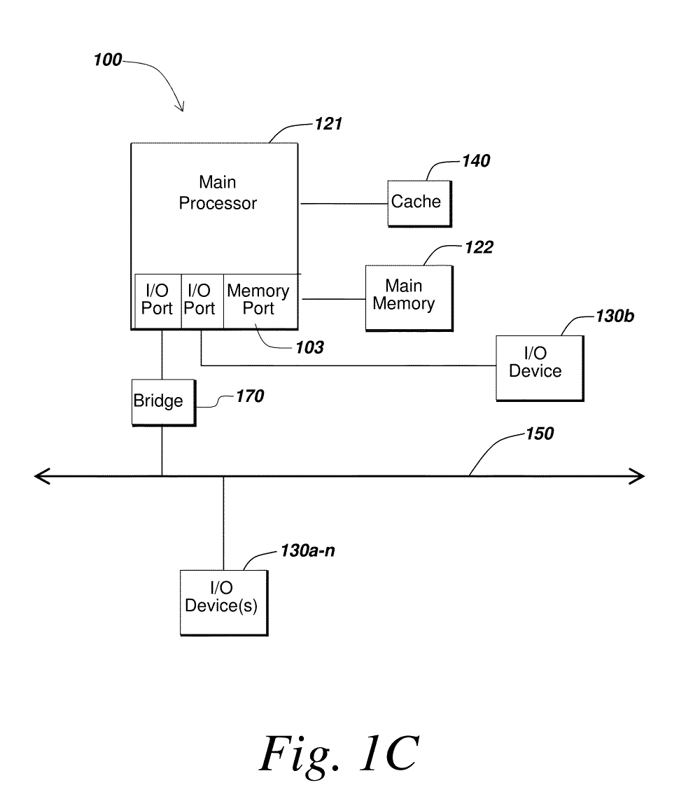

Referring now to FIG. 1A, an embodiment of a network environment is depicted. In brief overview, the network environment comprises one or more clients 102a-102n (also generally referred to as local machine(s) 102, client(s) 102, client node(s) 102, client machine(s) 102, client computer(s) 102, client device(s) 102, computing device(s) 102, endpoint(s) 102, or endpoint node(s) 102) in communication with one or more remote machines 106a-106n (also generally referred to as server(s) 106 or computing device(s) 106) via one or more networks 104.

Although FIG. 1A shows a network 104 between the clients 102 and the remote machines 106, the clients 102 and the remote machines 106 may be on the same network 104. The network 104 can be a local area network (LAN), such as a company Intranet, a metropolitan area network (MAN), or a wide area network (WAN), such as the Internet or the World Wide Web. In some embodiments, there are multiple networks 104 between the clients 102 and the remote machines 106. In one of these embodiments, a network 104′ (not shown) may be a private network and a network 104 may be a public network. In another of these embodiments, a network 104 may be a private network and a network 104′ a public network. In still another embodiment, networks 104 and 104′ may both be private networks.

The network 104 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network, and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS, or UMTS. In some embodiments, different types of data may be transmitted via different protocols. In other embodiments, the same types of data may be transmitted via different protocols.

A client 102 and a remote machine 106 (referred to generally as computing devices 100) can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client 102 may execute, operate or otherwise provide an application, which can be any type and/or form of software, program, or executable instructions, including, without limitation, any type and/or form of web browser, web-based client, client-server application, ActiveX control, or Java applet, or any other type and/or form of executable instructions capable of executing on client 102.

In one embodiment, a computing device 106 provides functionality of a web server. In some embodiments, a web server 106 comprises an open-source web server, such as the APACHE servers maintained by the Apache Software Foundation of Delaware. In other embodiments, the web server executes proprietary software, such as the Internet Information Services products provided by Microsoft Corporation of Redmond, Wash.; the Oracle iPlanet web server products provided by Oracle Corporation of Redwood Shores, Calif.; or the BEA WEBLOGIC products provided by BEA Systems of Santa Clara, Calif.

In some embodiments, the system may include multiple, logically grouped remote machines 106. In one of these embodiments, the logical group of remote machines may be referred to as a server farm 38. In another of these embodiments, the server farm 38 may be administered as a single entity.

FIGS. 1B and 1C depict block diagrams of a computing device 100 useful for practicing an embodiment of the client 102 or a remote machine 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-n, a keyboard 126, a pointing device 127, such as a mouse, and one or more other I/O devices 130a-n. The storage device 128 may include, without limitation, an operating system and software. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121. The main memory 122 may be based on any available memory chips capable of operating as described herein. In the embodiment shown in FIG. 1B, the processor 121 communicates with main memory 122 via a system bus 150. FIG. 1C depicts an embodiment of a computing device 100 in which the processor communicates directly with main memory 122 via a memory port 103. FIG. 1C also depicts an embodiment in which the main processor 121 communicates directly with cache memory 140 via a secondary bus, sometimes referred to as a backside bus. In other embodiments, the main processor 121 communicates with cache memory 140 using the system bus 150.

In the embodiment shown in FIG. 1B, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 also communicates directly with an I/O device 130b via, for example, HYPERTRANSPORT, RAPIDIO, or INFINIBAND communications technology.

A wide variety of I/O devices 130a-130n may be present in the computing device 100. Input devices include keyboards, mice, trackpads, trackballs, microphones, scanners, cameras, and drawing tablets. Output devices include video displays, speakers, inkjet printers, laser printers, and dye-sublimation printers. An I/O controller 123 as shown in FIG. 1B may control the I/O devices. Furthermore, an I/O device may also provide storage and/or an installation medium 116 for the computing device 100. In some embodiments, the computing device 100 may provide USB connections (not shown) to receive handheld USB storage devices such as the USB Flash Drive line of devices manufactured by Twintech Industry, Inc. of Los Alamitos, Calif.

Referring still to FIG. 1B, the computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, tape drives of various formats, USB device, hard-drive, or any other device suitable for installing software and programs. The computing device 100 may further comprise a storage device, such as one or more hard disk drives or redundant arrays of independent disks, for storing an operating system and other software.

Furthermore, the computing device 100 may include a network interface 118 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax, and direct asynchronous connections). In one embodiment, the computing device 100 communicates with other computing devices 100′ via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem, or any other device suitable for interfacing the computing device 100 to any type of network capable of communication and performing the operations described herein.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, and WINDOWS VISTA, all of which are manufactured by Microsoft Corporation of Redmond, Wash.; MAC OS manufactured by Apple Inc. of Cupertino, Calif.; OS/2 manufactured by International Business Machines of Armonk, N.Y.; and Linux, a freely-available operating system distributed by Caldera Corp. of Salt Lake City, Utah, or any type and/or form of a UNIX operating system, among others.

The computing device 100 can be any workstation, desktop computer, laptop or notebook computer, server, portable computer, mobile telephone or other portable telecommunication device, media playing device, a gaming system, mobile computing device, or any other type and/or form of computing, telecommunications, or media device that is capable of communication and that has sufficient processor power and memory capacity to perform the operations described herein. In some embodiments, the computing device 100 may have different processors, operating systems, and input devices consistent with the device. In other embodiments, the computing device 100 is a mobile device, such as a JAVA-enabled cellular telephone or personal digital assistant (PDA). The computing device 100 may be a mobile device such as those manufactured, by way of example and without limitation, by Motorola Corp. of Schaumburg, Ill.; Kyocera of Kyoto, Japan; Samsung Electronics Co., Ltd. of Seoul, Korea; Nokia of Finland; Hewlett-Packard Development Company, L.P. and/or Palm, Inc., of Sunnyvale, Calif.; Sony Ericsson Mobile Communications AB of Lund, Sweden; or Research In Motion Limited of Waterloo, Ontario, Canada. In yet other embodiments, the computing device 100 is a smart phone, Pocket PC, Pocket PC Phone, or other portable mobile device supporting Microsoft Windows Mobile Software.

In some embodiments, the computing device 100 is a digital audio player. In one of these embodiments, the computing device 100 is a digital audio player such as the Apple IPOD, IPOD Touch, IPOD NANO, and IPOD SHUFFLE lines of devices manufactured by Apple Inc. of Cupertino, Calif. In another of these embodiments, the digital audio player may function as both a portable media player and as a mass storage device. In other embodiments, the computing device 100 is a digital audio player such as those manufactured by, for example, and without limitation, Samsung Electronics America of Ridgefield Park, N.J.; Motorola Inc. of Schaumburg, Ill.; or Creative Technologies Ltd. of Singapore. In yet other embodiments, the computing device 100 is a portable media player or digital audio player supporting file formats including, but not limited to, MP3, WAV, M4A/AAC, WMA Protected AAC, AEFF, Audible audiobook, Apple Lossless audio file formats and .mov, .m4v, and .mp4 MPEG-4 (H.264/MPEG-4 AVC) video file formats.

In some embodiments, the computing device 100 comprises a combination of devices, such as a mobile phone combined with a digital audio player or portable media player. In one of these embodiments, the computing device 100 is a device in the Motorola line of combination digital audio players and mobile phones. In another of these embodiments, the computing device 100 is a device in the iPhone smartphone line of devices, manufactured by Apple Inc. of Cupertino, Calif. In still another of these embodiments, the computing device 100 is a device executing the Android open source mobile phone platform distributed by the Open Handset Alliance; for example, the device 100 may be a device such as those provided by Samsung Electronics of Seoul, Korea, or HTC Headquarters of Taiwan, R.O.C. In other embodiments, the computing device 100 is a tablet device such as, for example and without limitation, the iPad line of devices manufactured by Apple Inc.; the PlayBook manufactured by Research in Motion; the Cruz line of devices manufactured by Velocity Micro, Inc. of Richmond, Va.; the Folio and Thrive line of devices manufactured by Toshiba America Information Systems, Inc. of Irvine, Calif.: the Galaxy line of devices manufactured by Samsung; the HP Slate line of devices manufactured by Hewlett-Packard; and the Streak line of devices manufactured by Dell, Inc. of Round Rock, Tex.

In some embodiments, the methods and systems described herein provide users with functionality for tracking a level of mastery over a word. In one of these embodiments, by determining that a reader has requested assistance with sight-reading a word while the reader is attempting to read silently, the system determines that the reader is struggling with sight-reading the word and can automatically identify the word as a challenging word for the reader. In some embodiments, by providing functionality for tracking words that are challenging to the reader, while the reader is attempting to read, the methods and systems described herein provide an improved experience for the reader. In one of these embodiments, for example, the reader does not need to try to remember words that are challenging after finishing the book; nor does the reader need to interrupt the reading experience to make note of challenging words while reading. In other embodiments, by automatically tracking words that are challenging to the reader during the attempt to read the words and providing the tracked words to an instructor, the methods and systems described herein provide an improved experience for the reader. In one of these embodiments, for example, the system may provide the tracked words to an instructor on behalf of the reader; such a system avoids the need for the reader to call attention to herself in seeking out the instructor's assistance, as well as avoiding the need for the reader to remember to tell the instructor of the challenging word after the reading experience or to interrupt the reading experience to seek out immediate assistance; such an embodiment increases the likelihood that the instructor will learn which words are challenging to the reader and assist the reader. Users of the system may be referred to as readers, a term including individuals who are able to read, individuals who are learning to read, and individuals seeking to improve their reading skills; readers may also include individuals who are learning to read or seeking to improve their reading skills in a foreign language. In some embodiments, methods and systems described herein provide functionality for identifying, reviewing and mastering new words in an effort to improve sight-reading, increase vocabulary, improve pronunciation, and generally improve a user's facility in speaking and reading a language.

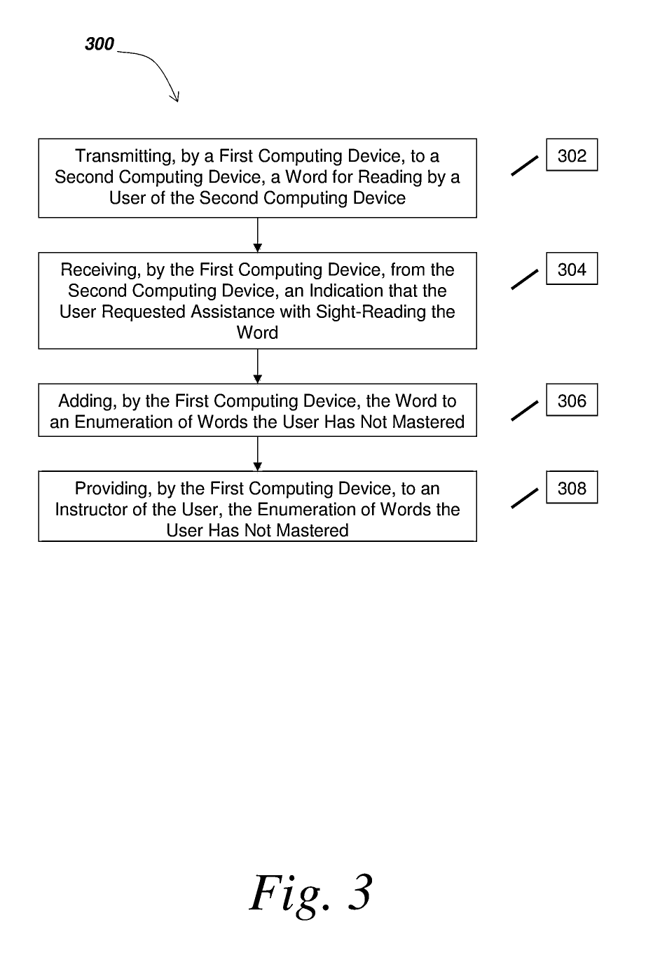

Referring now to FIG. 3, a flow diagram depicts one embodiment of a method 300 for tracking words to be mastered. In brief overview, the method 300 includes transmitting, by a first computing device, to a second computing device, a word for reading by a user of the second computing device (302). The method 300 includes receiving, by the first computing device, from the second computing device, an indication that the user requested assistance with sight-reading the word (304). The method 300 includes adding, by the first computing device, the word to an enumeration of words the user has not mastered (306). The method 300 includes providing, by the first computing device, to an instructor of the user, the enumeration of words the user has not mastered (308).

The instructor may be, by way of example and without limitation, a professional educator (such as a school teacher), an informal educator (such as a tutor), a parent, or other individual instructing the user formally or informally. The user may be anyone seeking to track a level of mastery over words, including, by way of example and without limitation, a person using the system as part of a formal education process (e.g., at school) or as part of an informal education process. Although the illustrative examples provided herein may refer to a student and the student's parents and teachers, it should be understood that any individual tracking his or her level of mastery over words could use the methods and systems described herein.

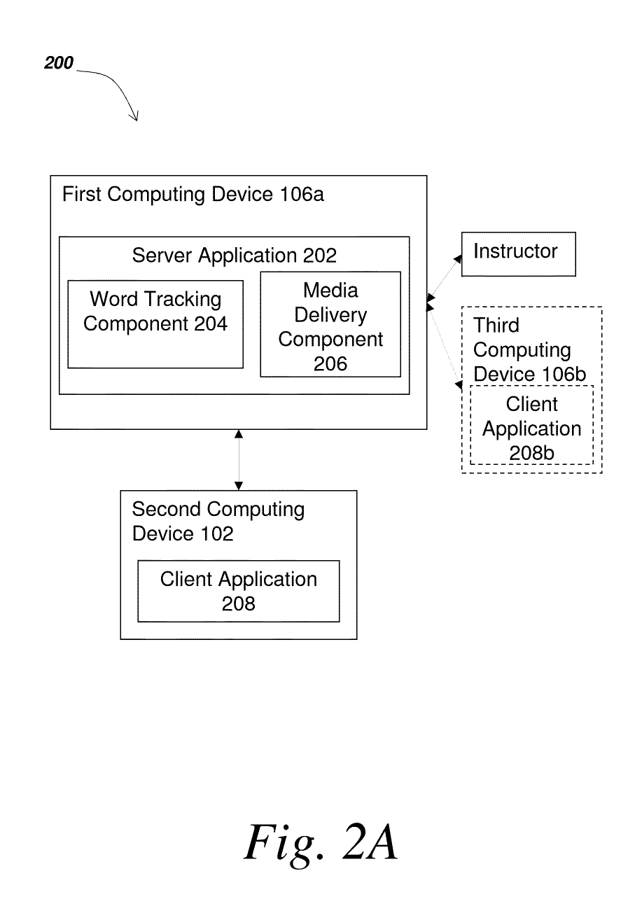

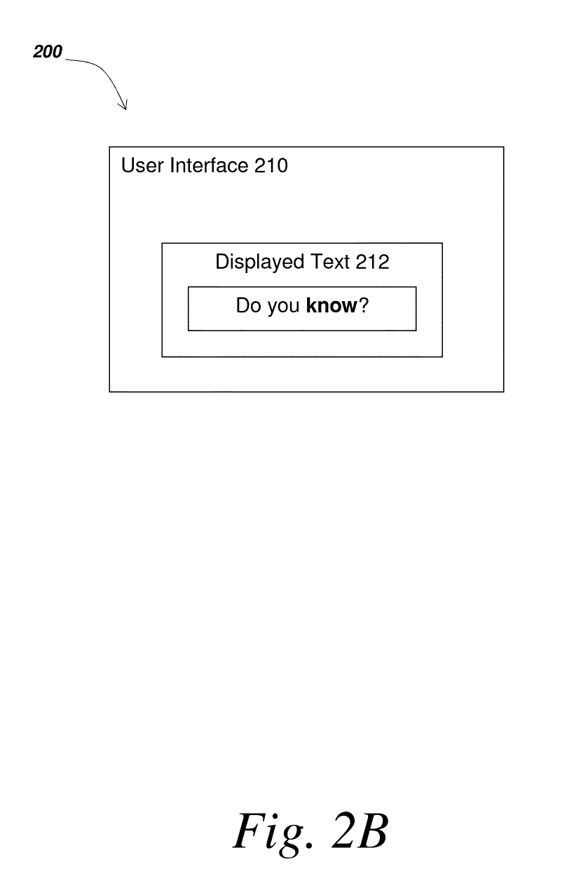

Referring still to FIG. 3, in connection with FIG. 2A, a first computing device transmits, to a second computing device, a word for reading by a user of the second computing device (302). In some embodiments, the first computing device 106a and the second computing device 102 are computers as described above in connection with FIGS. 1A-1C. In other embodiments, depicted in shadow in FIG. 2A, the system includes a third computing device 106b, which may also be provided as a computer as described above in connection with FIGS. 1A-1C.

Referring to FIG. 2A, and in one embodiment, the first computing device 106a executes a server application 202. In another embodiment, the server application 202 includes a word tracking component 204. In another embodiment, the server application 202 includes a media delivery component 206. In still another embodiment, the media delivery component 206 transmits the word for reading to the second computing device 102.

In one embodiment, the second computing device 102 executes a client application 208. In another embodiment, the client application 208 receives the word for reading from the first computing device 106a.

In one embodiment, the media delivery component 206 transmits, to the client application 208, one or more words for reading by the user of the second computing device 102. In another embodiment, the media delivery component 206 transmits at least one graphic for display to the user reading the word. For example, the media delivery component 206 may transmit the text of a book and accompanying illustrations for display to the user. In still another embodiment, the media delivery component 206 transmits, to the client application 208, an audio file containing a recording of the word. For example, the media delivery component 206 may transmit an audio file containing a recording of the word, which the client application 208 can play to the user of the second computing device 102 (e.g., if the user is reading the word “dinosaur,” the client application 208 may open the audio file to reproduce the sound of a speaker saying the word “dinosaur”). In some embodiments, the audio file may contain a recording of a definition of the word. In other embodiments, the audio file may contain a recording of the word used in a sentence or in the context of a story. In further embodiments, the audio file contains a recording of the word spoken aloud in a different language than the language in which the client application 208 displayed the word to the user (e.g., the client application 208 may display the Spanish word “dinosaurio” and the audio file may contain a recording of the word “dinosaur” spoken in English).

In one embodiment, the media delivery component 206 transmits, to the client application 208, a plurality of media files for use in displaying, to the user of the second computing device 102, the text of a book with accompanying illustrations and a soundtrack the user may optionally play when reading the text. For example, and without limitation, the first computing device 106a may store a collection of books available for reading in an electronic format and may provide a book in the collection of books to the second computing device 102 upon receiving a request over the network 104.

Through the use of audio files transmitted to the second computing device 102, the client application 208 may “read” a book to pre-reader users. However, in some embodiments, users may elect not to use the audio files that contain the entire text of the book, opting instead for the selective use of audio files containing recordings of particular words. In one of these embodiments, the client application 208 determines that the user is attempting to sight-read the book, since the user decided not to hear the audio for the entire book. In an embodiment in which the user is attempting to sight-read the book, the client application 208 may determine that using an audio file containing a recording of a particular word indicates that the user struggled to sight-read the word because the user asked to hear what the word sounds like when spoken aloud.

In one embodiment, the client application 208 displays the word received from the media delivery component 206 to a user (e.g., via the display device 124). In another embodiment, the client application 208 generates a user interface in which to display the media received from the media delivery component 206 (e.g., words or illustrations or both). In some embodiments, the client application 208 associates a display of the word with a command to play an audio file containing a recording of the word such that when the user selects the word within the user interface, the audio file begins to play (e.g., through the use of markup languages such as HyperText Markup Language or eXensible Markup Language, or the use of functionality provided by executing applications such as the ADOBE FLASH technology manufactured and distributed by Adobe Systems Incorporated of Seattle, Wash.). In one of these embodiments, the user may play the audio file an unlimited number of times.

Referring now to FIG. 3 in connection with FIG. 2B, the client application 208 receives a request for assistance with sight-reading the word. As shown in FIG. 2B, the client application 208 generates a user interface 210 that displays text 212. As an example, if the client application 208 received the words “do,” “you,” and “know?” from the media delivery component 206, the displayed text 212 would include the phrase “do you know?”. In some embodiments, the user interface 210 may alter the display of a word when the user interacts with the displayed text 212; for example, the user interface 210 may bold, italicize, modify a color, or otherwise alter the displayed text 212 when the user (e.g., via a pointing device 127) positions a cursor over the displayed text 212 or issues a command to interact with the displayed text 212 (e.g., via the pointing device 127, the user “clicks on” the displayed text). In one embodiment, when the user clicks on displayed text 212, the client application 208 transmits a notification to the word tracking component 204.

Referring to FIG. 3, again in connection with FIG. 2A, the first computing device receives, from the second computing device, an indication that the user requested assistance with sight-reading the word (304). In one embodiment, a word tracking component 204 executing on the first computing device 106a receives the indication. In another embodiment, the word tracking component 204 receives a notification that the user interacted with a display of the word via a pointing device 127 (e.g., the user “clicked” on the displayed word using a pointing device 127). In still another embodiment, the word tracking component 204 receives a command to store the word.

In some embodiments, the word tracking component 204 and the client application 208 communicate using an application programming interface (API). In one of these embodiments, the client application 208 uses commands as specified by the API to transmit the notification that the user requested assistance sight-reading the word and instructions to store the word in the enumeration of words the user cannot sight-read. In another of these embodiments, the media delivery component 206 uses commands as specified by the API to transmit the word, media files, and the enumeration to the client application 208.

The first computing device adds the word to an enumeration of words the user has not mastered (306). In one embodiment, the word tracking component 204 stores the enumeration in storage 128. In another embodiment, the word tracking component 204 stores the enumeration in a database. In some embodiments, the database is an ODBC-compliant database. For example, the database may be provided as an ORACLE database manufactured by Oracle Corporation of Redwood Shores, Calif. In other embodiments, the database can be a Microsoft ACCESS database or a Microsoft SQL server database manufactured by Microsoft Corporation of Redmond, Wash. In still other embodiments, the database may be a custom-designed database based on an open source database, such as the MYSQL family of freely available database products distributed by MySQL AB Corporation of Uppsala, Sweden. In other embodiments, examples of databases include, without limitation, structured storage (e.g., NoSQL-type databases and BigTable databases), HBase databases distributed by The Apache Software Foundation of Forest Hill, Md.; MongoDB databases distributed by 10Gen, Inc., of New York, N.Y.; and Cassandra databases distributed by The Apache Software Foundation of Forest Hill, Md. In further embodiments, the database may be any form or type of database.

In some embodiments, the word tracking component 204 queries the database to determine whether the word is already stored in the enumeration. In one of these embodiments, the word tracking component 204 does not store duplicate words. In another of these embodiments, the word tracking component 204 does store duplicate words. In still another of these embodiments, the word tracking component 204 applies a user-specified rule to determine whether or not to delete duplicate words. In other embodiments, the word tracking component 204 includes in the enumeration of words the user has not mastered an identification of a context in which the user attempted to read the word. In one of these embodiments, for example, the word tracking component 204 stores an identification of a book the user was attempting to read silently when the user encountered the word. As another example, the context may indicate a part of speech or a way in which the word is used in a sentence. In another of these embodiments, the word tracking component 204 queries the database to determine whether the word and the identification of the context are already stored in the enumeration; in such an embodiment, the word tracking component 204 may store a duplicate word if the word appeared in different contexts.

The first computing device provides, to an instructor of the user, the enumeration of words the user has not mastered (308). In some embodiments, the word tracking component 204 provides, to an instructor of the user, the enumeration of words the user has not mastered. In one embodiment, by way of example, the instructor accesses the first computing device 106a directly to access the enumeration of words. In another embodiment, the word tracking component 204 provides, to a third computing device 106b (depicted in shadow in FIG. 2), the enumeration of words across a network 104. For example, the third computing device 106b may be a computer accessed by a student (e.g., where the student used the system from a school computer but wishes to review the enumeration from a home computer), the student's instructor, or a parent of the student.

In some embodiments, the word tracking component 204 transmits, to the second computing device 102, the enumeration of words the user has not mastered. In further embodiments, the media delivery component 206 provides, to the client application 208, an exercise for mastering, by the user, the word. In one of the embodiments, by way of example, the media delivery component 206 delivers a game in which the user can practice reading the word. Other examples of exercises for mastering words include, without limitation, exercises in which the user identifies groups of letters within a word and reviews other words containing similar groupings (prefixes, roots, suffixes) or exercises in which users review words that rhyme with the word. In some embodiments, the system leverages social networking sites to provide access to collaborative exercises.

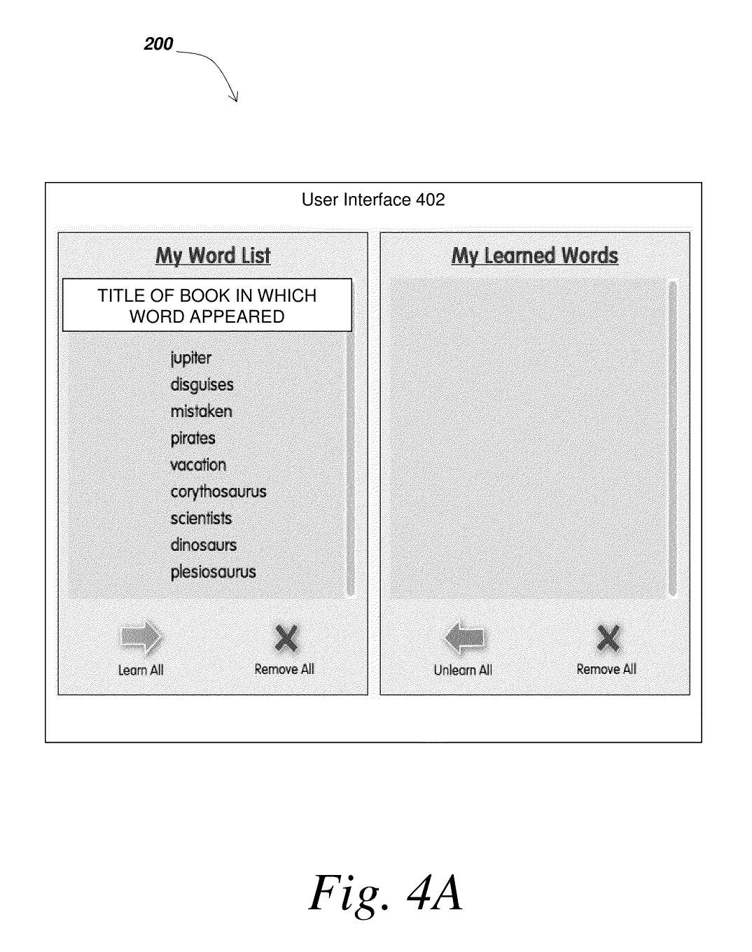

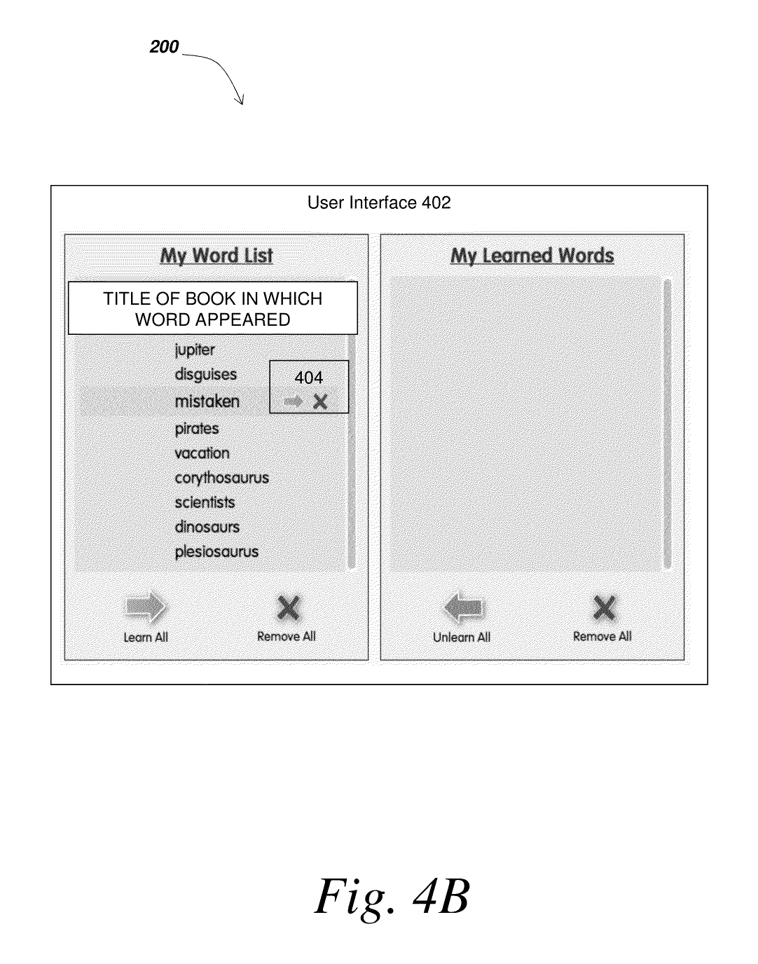

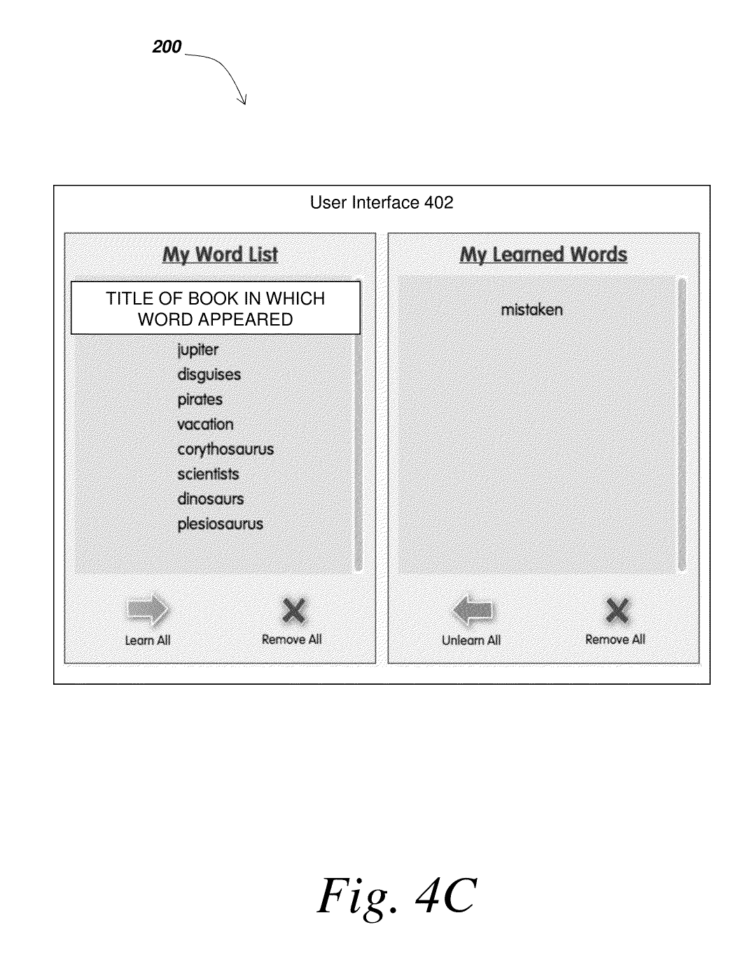

Referring now to FIG. 4A, a screen shot depicts one embodiment of a user interface for viewing the enumeration of words the user has not mastered. As shown in FIG. 4A, the client application 208 generates a user interface 402 displaying the enumeration of words the user has not mastered. In the illustrative example shown in FIG. 4A, the user requested assistance with particular words (e.g., disguises, scientists, plesiosaurus, etc.) when sight-reading a book (e.g., by clicking on the word to have the word read aloud), the client application 208 transmitted an indication of the words to the word tracking component 204, which added the words to the enumeration. In some embodiments, the word tracking component 204 transmits the enumeration of words to the client application 208 for use in displaying the enumeration to the user. As shown in FIG. 4A, the client application 208 may provide a user interface 402 with which the user can review words that challenged the user. The client application 208 may display the user interface 402 before the user attempts to read a challenging word again or after the user completes an initial attempt to read the challenging word (for example, before or after the user attempts to sight-read a book in which the challenging word appears). In some embodiments, the user can interact with the word displayed in the user interface 402, for example to request that the client application 208 play a recording of the spoken word or to request access to an exercise in which the user can practice reading the word. In embodiments where the word tracking component 204 transmits the enumeration of words to the third computing device 106b, a second client application 208b (depicted in shadow in FIG. 2A) may generate and display the user interface 402.

Referring now to FIG. 4B, a screen shot depicts one embodiment of a user interface for modifying an enumeration of words the user has not mastered. As shown in FIG. 4B, the user interface 402 includes an interface element 404 with which the user may modify the enumeration of words. When the user selects a word in the displayed enumeration of words, the user interface 402 displays the interface element 404 with which the user can request that the system delete the word from the list or move the word to an enumeration of words the user has mastered.

In one embodiment, when the user adds the word to the enumeration of words the user has mastered, the client application 208 transmits, to the word tracking component 204, an indication that the user has mastered sight-reading the word. In another embodiment, the first computing device 106a receives, from the second computing device, the indication that the user has mastered sight-reading the word. In still another embodiment, the word tracking component 204 removes the word from the enumeration of words the user has not mastered. In still another embodiment, the word tracking component 204 adds the word to the enumeration of words the user has mastered.

Referring now to FIG. 4C, a screen shot depicts one embodiment of a user interface reflecting a user-initiated modification to the enumeration of words the user has not mastered. As shown in FIG. 4C, the user selected the word “mistaken” from the enumeration of words the user has not mastered and requested that the system move the word to the enumeration of words the user has mastered, the client application 208 and the word tracking component 204 made the appropriate modifications, and the word “mistaken” now appears in the enumeration of words the user has mastered.

In some embodiments, the word tracking component 204 provides functionality for tracking the history of an individual's attempts to sight-read words. In other embodiments, the word tracking component 204 provides functionality for reviewing and practicing words previously identified as challenging in a clear and organized manner. In some embodiments, by allowing the user to identify challenging words while the user is attempting to read the words, the methods and systems described herein provide improved systems for tracking words to be mastered since the system identifies the words based on user interaction that indicates the user finds the word challenging—as opposed to words identified because an instructor thinks the user finds challenging, which may be over- or under-inclusive—and the system makes the identification unobtrusively, during the attempt to sight-read, which does not require the user to interrupt the reading experience or attempt to later recall which words were challenging. In further embodiments, the methods and systems described herein provide functionality for automatically and unobtrusively generating a visual representation of the progress a user is making in improving literacy skills and increasing vocabulary.

It should be understood that the systems described above may provide multiple ones of any or each of those components and these components may be provided on either a standalone machine or, in some embodiments, on multiple machines in a distributed system. The phrases ‘in one embodiment,’ in another embodiment,' and the like, generally mean that the particular feature, structure, step, or characteristic following the phrase is included in at least one embodiment of the present disclosure and may be included in more than one embodiment of the present disclosure. However, such phrases do not necessarily refer to the same embodiment.

The systems and methods described above may be implemented as a method, apparatus or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., an integrated circuit chip; an electronic device; a computer-readable non-volatile storage unit; non-volatile memory, such as semiconductor memory devices including EPROM, EEPROM, and flash memory devices; magnetic disks, such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data from a second computer providing access to the programs via a network transmission line, wireless transmission media, signals propagating through space, radio waves, infrared signals, etc.

Having described certain embodiments of methods and systems for tracking words to be mastered, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for tracking words to be mastered, the method comprising:
transmitting, by a first computing device, to a second computing device, a word for reading by a user of the second computing device;
receiving, by the first computing device, from the second computing device, an indication that the user requested assistance with sight-reading the word;
adding, by the first computing device, the word to an enumeration of words the user has not mastered; and
providing, by the first computing device, to an instructor of the user, the enumeration of words the user has not mastered.

2. The method of claim 1, wherein providing further comprises providing, by the first computing device, to a third computing device associated with the instructor of the user, the enumeration of words the user has not mastered.

3. The method of claim 1 further comprising transmitting, by the first computing device, to the second computing device, the enumeration of words the user has not mastered.

4. The method of claim 1 further comprising transmitting, by the first computing device, to the second computing device, an audio file containing a recording of the word.

5. The method of claim 1 further comprising transmitting, by the first computing device, to the second computing device, an exercise for mastering, by the user, the word.

6. The method of claim 1 further comprising receiving, by the first computing device, from the second computing device, an indication that the user has mastered sight-reading the word.

7. The method of claim 6 further comprising removing, by the first computing device, the word from the enumeration of words the user has not mastered.

8. The method of claim 6 further comprising adding, by the first computing device, the word to an enumeration of words the user has mastered.

9. A computer readable medium having instructions thereon that when executed provide a method for tracking words to be mastered, the computer readable medium comprising:
instructions to transmit, by a first computing device, to a second computing device, a word for reading by a user of the second computing device;
instructions to receive, by the first computing device, from the second computing device, an indication that the user requested assistance with sight-reading the word;
instructions to add, by the first computing device, the word to an enumeration of words the user has not mastered; and
instructions to provide, by the first computing device, to an instructor of the user, the enumeration of words the user has not mastered.

10. The computer readable medium of claim 9, wherein providing further comprises instructions to provide, by the first computing device, to a third computing device associated with the instructor of the user, the enumeration of words the user has not mastered.

11. The computer readable medium of claim 9 further comprising instructions to transmit, by the first computing device, to the second computing device, the enumeration of words the user has not mastered.

12. The computer readable medium of claim 9 further comprising instructions to transmit, by the first computing device, to the second computing device, an audio file containing a recording of the word.

13. The computer readable medium of claim 9 further comprising instructions to transmit, by the first computing device, to the second computing device, an exercise for mastering, by the user, the word.

14. The computer readable medium of claim 9 further comprising instructions to receive, by the first computing device, from the second computing device, an indication that the user has mastered sight-reading the word.

15. The computer readable medium of claim 14 further comprising instructions to remove, by the first computing device, the word from the enumeration of words the user has not mastered.

16. The computer readable medium of claim 14 further comprising instructions to add, by the first computing device, the word to an enumeration of words the user has mastered.

17. A system for tracking words to be mastered comprising:
a media delivery component executing on a first computing device and transmitting, to a client application executing on a second computing device, a word for reading by a user of the second computing device; and
a word tracking component (i) executing on the first computing device, (ii) receiving, from the second computing device, an indication that the user requested assistance with sight-reading the word, (iii) adding the word to an enumeration of words the user has not mastered, and (iv) providing, by the first computing device, to an instructor of the user, the enumeration of words the user has not mastered.
